(19) United States
(12) Patent Application Publication
(10) Pub. No.: US 2021/0085069 A1
(43) Pub. Date: Mar. 25, 2021

(54) CLEANING DEVICE FOR BRUSHES

(71) Applicant: PEKA PINSELFABRIK AG, Ebnat-Kappel (CH)

(72) Inventors: Albert Johann LOICHINGER, Langnau Am Albis (CH); Christian LOCHER, Zürich (CH); Daniel BÄCHTOLD, Ebnat-Kappel (CH); Jürg NÜSSLI, Jona (CH)

(73) Assignee: PEKA PINSELFABRIK AG, Ebnat-Kappel (CH)

(21) Appl. No.: 16/956,402

(22) PCT Filed: Nov. 22, 2018
(86) PCT No.: PCT/CH2018/000046

§ 371 Date: Jun. 19, 2020

(30) Foreign Application Priority Data
Dec. 21, 2017 (CH) 1599/17

(51) Int. Cl. A46B 17/06

(52) U.S. Cl. CPC A46B 17/06; A46B 2200/205

(57) ABSTRACT

A cleaning apparatus for paintbrushes comprises a rotatable nozzle assembly has a plurality of nozzles as well as several paintbrush holders. In the paintbrush holders, paintbrushes can be held such that the nozzles are moved through their tuft during operation. A good cleaning effect can be achieved in this manner.

### REFERENCE TO RELATED APPLICATIONS

This invention claims the priority of Swiss patent application 01599/17, which was filed on Dec. 21, 2017, the complete disclosure of which is incorporated herein by reference.

### FIELD OF THE INVENTION

The invention relates to an apparatus for cleaning paintbrushes as well as to a method for operating the apparatus according to the preamble of the independent claims.

### BACKGROUND

Professionally cleaning paintbrushes after use has, in practice, great significance. In order to achieve a good result, the tuft of the paintbrush (i.e. its bristle or hair part) has to be cleaned from residues. This is usual carried out by means of a cleaning liquid, e.g. water (optionally with a rinsing or cleaning agent) or a solvent.

There are also devices that hold the paintbrush in a cleaning position, where its tuft is immersed into a cleaning bath or is sprayed at by from one or more nozzles.

### SUMMARY OF THE INVENTION

The problem to be solved is to provide a cleaning apparatus for paintbrushes by means of which a good cleaning efficiency can be achieved.

This problem is solved by the cleaning apparatus of claim 1.

Accordingly, the cleaning apparatus comprises at least the following components:
At least one paintbrush holder for positioning the tuft of a paintbrush in a cleaning region: hence, the paintbrush holder is adapted to hold the tuft of the paintbrush in the cleaning region.
At least one nozzle for treating the tuft in the cleaning region by means of a cleaning liquid: hence, the nozzle is arranged such that it is able to treat the tuft with a cleaning liquid.
A cleaning liquid feed for feeding the cleaning liquid to the nozzle. By means of this device, the nozzle is supplied with the cleaning liquid.
A motion device by means of which the nozzle can be moved relatively to the paintbrush through the cleaning region and therefore through the tuft: hence, a device is provided, by means of which the nozzle can be moved through the tuft. For this, the tuft, the nozzle, or both these parts may be moved.

By moving the nozzle through the tuft, intensive cleaning of the tuft is achieved. In particular, the nozzle and/or the cleaning liquid stir the hairs or bristles of the tuft strongly, and the cleaning liquid can enter deeply into the tuft and flush away residue.

In a preferred embodiment, the motion device is adapted to move the nozzle. In this case, the paintbrush may be in a fixed position during the cleaning process.

Thus, the motion device may comprise a rotatable nozzle holder and the drive for rotating the nozzle holder around a rotation axis. The at least one nozzle is mounted to the nozzle holder.

Further, the apparatus advantageously comprises a jet control pipe arranged within the rotatable nozzle holder and having at least one opening. This opening is located such that the nozzle communicates (only) over part of its rotation with the interior space of the jet control pipe. Further, the cleaning liquid feed feeds the cleaning liquid into the interior space of the let control pipe. In this manner, it can be achieved that cleaning liquid is only fed to the nozzle when it is located in the region of the tuft of the paintbrush. In this way, the cleaning liquid can be selectively directed to the correct location.

Advantageously, there are several nozzles. This allows to increase the cleaning efficiency and/or the tuft can be cleaned at different locations and/or several paintbrushes can be cleaned at the same time.

In this case, at least part of the nozzles can be located mutually displaced other along the rotational axis, i.e. at least one of the nozzles is located at different axial positions. This makes it possible to clean the tuft at. different locations, and/or several paintbrushes beside each other can be cleaned at the same time.

In addition or alternatively thereto, at least part of the nozzles can be arranged at the different angular positions around the rotational axis, i.e. at least part of the nozzles have, from a point of view of the rotational axis, differing directions. In this manner, these nozzles enter into contact with the tuft of the paintbrush at different times daring the rotation of the nozzle holder.

The paintbrush holder may have clamp for holding the handle of the paintbrush.

Advantageously the device comprises several paintbrush holders for several paintbrushes such that several paintbrushes can be cleaned at the same time. In this case, the paintbrush holders may be located spaced apart from each other along the rotational axis of the nozzle holder in order to cooperate with the nozzles at different locations.

The invention also relates to a method for operating the apparatus for cleaning paintbrushes where the nozzle is moved relatively to the paintbrush through the tuft.

Advantageously, cleaning liquid is injected through the nozzle while it is being moved through the tuft.

### BRIEF DESCRIPTION OF THE DRAWINGS

Other embodiments, advantages and applications of the invention result from the dependent claims as well as from the following description referring to the figures, wherein:

FIG. 1 shows a view of a cleaning apparatus,

FIG. 2 shows a sectional view of the apparatus of FIG. 1,

FIG. 3 shows a top view of the apparatus of FIG. 1 without cover,

FIG. 4 shows a view of a nozzle assembly,

FIG. 5 shows a top view of the nozzle assembly of FIG. 4,

FIG. 6 shows a sectional view along line B-B of FIG. 5,

FIG. 7 shows a view along line C-C of FIG. 5,

FIG. 8 shows a view of a paintbrush holder, and

FIG. 9 shows the paintbrush holder of FIG. 3 from the site.

### EMBODIMENTS OF THE INVENTION

Overview:

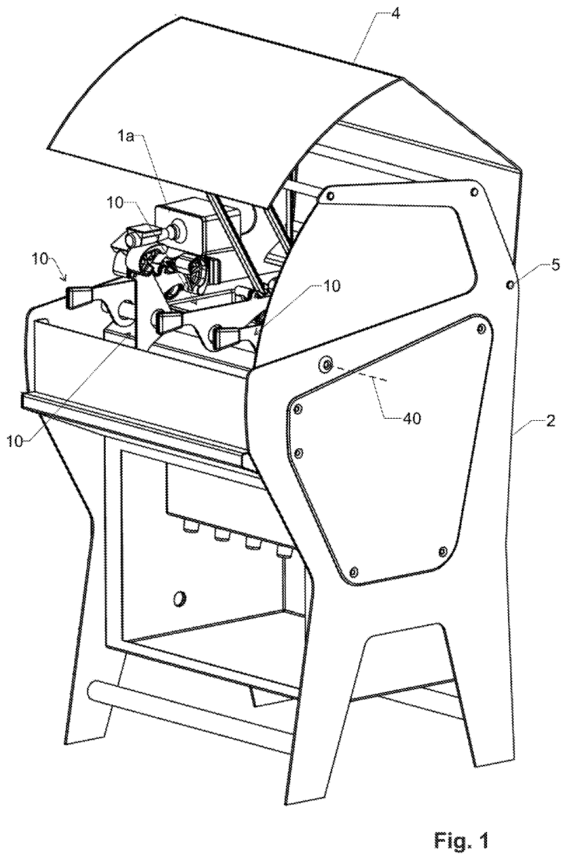

FIGS. 1-3 show a cleaning apparatus for paintbrushes 1a, 1b, 1c.

The device comprises a housing 2, in which a cleaning tub 3 is located. The cleaning tub 3 is accessible from above via a pivotal cover 4.

A rotatable nozzle assembly 6 is arranged within cleaning tub 3, with a plurality of nozzles 8 mounted thereon. The design of the nozzle assembly 6 is described in more detail below.

Further several paintbrush holders 10 are located under cover 4. Their purpose is to hold the paintbrushes 1a, 1b, 1c in such a manner that they can be cleaned.

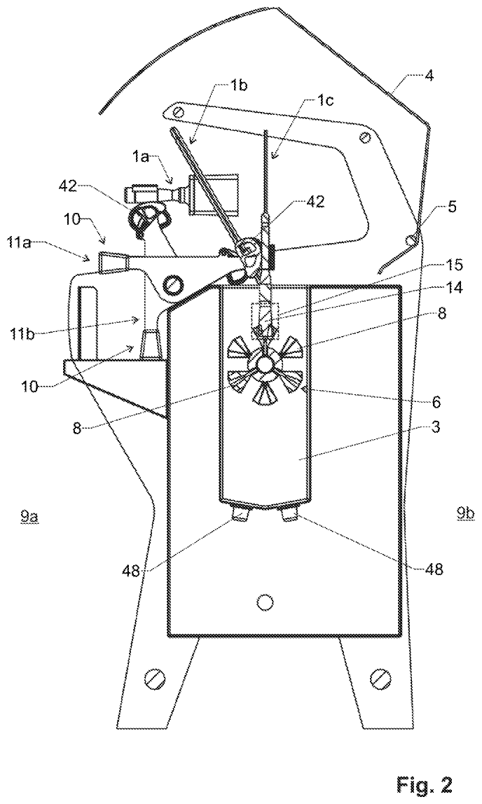

In operation of the device, the paintbrushes 1a, 1b, 1c are positioned such that their tufts 14 (i.e. their hair or bristles, cf. FIG. 2) are located in a tuft region 15 of the cleaning tub 3, through which the nozzles are moving.

When the nozzles 8 move through the tuft 14, they eject cleaning liquid, whereby the cleaning action is intensified.

The cleaning apparatus comprises a user side 9a and a backside 9b opposite to the user side 9a (see FIG. two, three). The cover 4 can preferably be moved upwards around a pivot axis 5 (FIG. 2), which axis is located in the region of the backside 9b of the apparatus, such that, in an opened position, it provides access to the interior of the device from the user side 9a.

Nozzle Assembly:

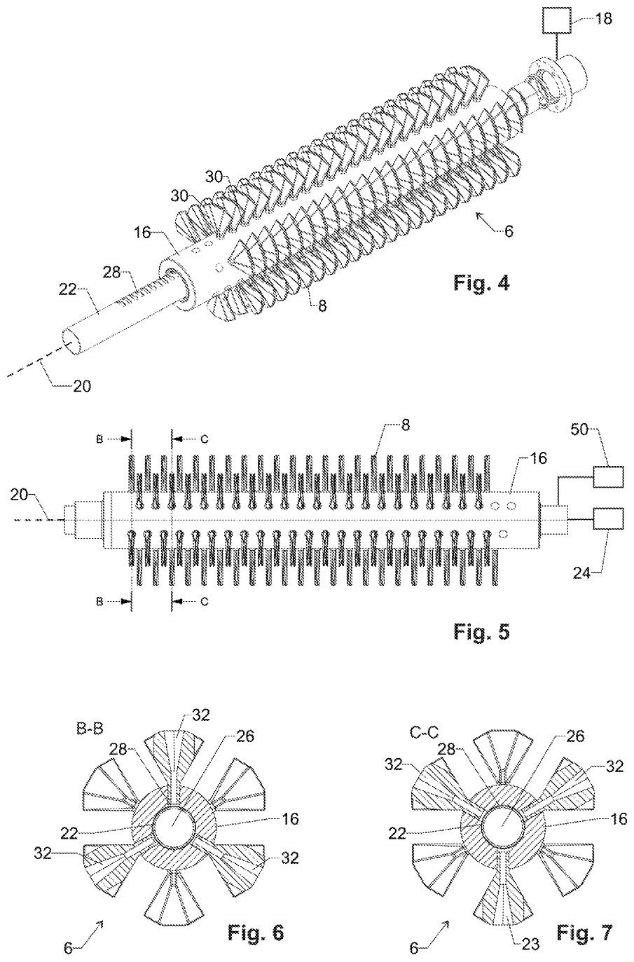

The nozzle assembly is best seen in FIGS. 4-7. It has a nozzle holder 16, to which the nozzles 8 are mounted. The nozzle holder 16 can be rotated about the rotation axis 20 by means of a drive, which is schematically shown in FIG. 4 under reference number 18.

The rotational axis 20 advantageously extends horizontally.

The nozzle holder 16 has a cylindrical interior space coaxial to the rotational axis 20, where a jet control pipe 22 is arranged, which is shown in FIG. 4 in partially exploded view.

Cleaning liquid can be fed to the interior space 26 of the jet control pipe 22 by means of a cleaning liquid feed 24, which is schematically shown in FIG. 5.

The cleaning liquid feed 24 can, for example, be designed as a circulation pump, which removes cleaning liquid from cleaning tub 3 and feeds the same via feeding means to the interior space 26 of the jet control pipe 22.

As shown in FIGS. 4, 6, and 7, several openings 28 are provided along a row on jet control pipe 22. They are facing the tuft space 15 and act as valve openings, which open the nozzles 8 when they are directed towards the tuft space 16.

The jet control pipe 20 is stationary arranged in nozzle holder 16 while the nozzle holder radially encloses the jet control pipe 22 and rotates, during operation, around the jet control pipe 22.

As further seen in FIGS. 4-7, the nozzles 8 are distributed axially and tangentially around the nozzle holder 16.

In the shown embodiment, there are several nozzles 8 at the same axial position (i.e. position along the rotational axis 20), for example three. Nozzles 8 that are axially adjacent to each other are tangentially offset, such that they are activated at different angular positions of the nozzle holder 16. This renders the flow of the cleaning liquid steadier.

Axially spaced apart nozzles 8 are provided, i.e. there are nozzles at different axial positions (i.e. Positions along the rotational axis 20).

The optimum axial spacing of adjacent nozzles depends on the nature of the tuft and the size of the paintbrushes. For painter's paintbrushes, a suitable distance is larger than 0.2 cm and/or smaller than 2 cm.

As can best be seen from FIG. 4, each nozzle has at least one entry edge 13 which is at the front along the motional direction of the nozzle, i.e. it is the edge that enters the tuft first. Starting from this edge 13, the nozzle widens towards its rear side, such that it spreads the tuft outwards by entering the same.

In the embodiment of FIG. 4, two entry edges 13 are provided at opposite sides of each nozzle. This allows rotating the nozzle, assembly 6 in both directions, for example once in a forward direction and later in a backwards direction, which improves the cleaning effect.

A liquid channel 32 extends through each nozzle 8 (FIG. 6, 7), which runs, advantageously in radial direction, from the jet control pipe 22 to the radially outward end of the nozzle 8. When the liquid channel 32 communicates with one of the openings of the et control pipe 22, the nozzle ejects cleaning liquid.

The nozzle holder 16 and the nozzles 8 attached thereto are located in the cleaning tub 3 of the cleaning apparatus.

Paintbrush Holder:

The cleaning apparatus comprises one or more paintbrush holders 10 for the paintbrushes. In the shown embodiment, there are three of them, but there may also be only one paintbrush holder, or there may be two or more than three paintbrush holders.

Each paintbrush holder 10 is adapted to hold at least one paintbrush during the cleaning procedure.

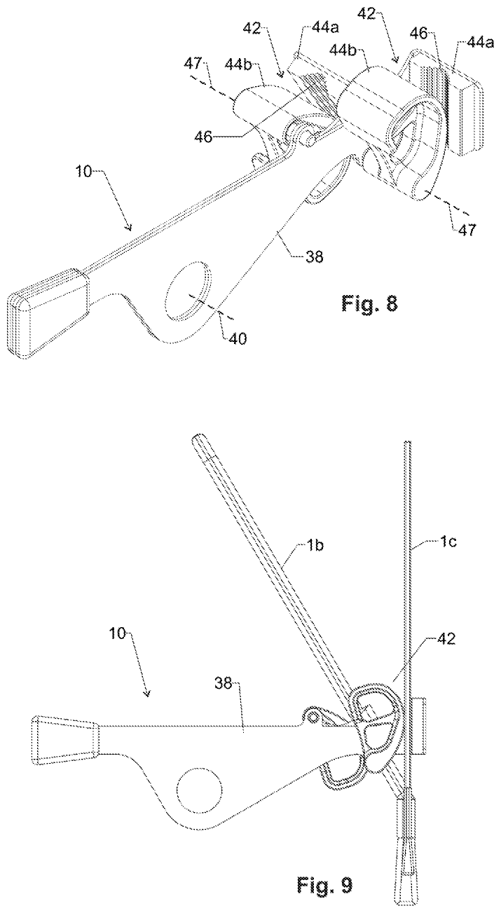

In the embodiment of FIGS. 8 and 9, the paintbrush holder has gripping lever 38 pivotal about a holder axis 40 extending parallel, preferably horizontally, along rotational axis 20 (see FIGS. 1, 3, and 8). Advantageously, the paintbrush holder 10 can be pivoted about at least 90°.

The paintbrush holder 10 can be moved, by pivoting in about the pivotal axis 40, from a service position to an operating position. In the embodiment of FIG. 1, the second paintbrush holder from the left is in the service position, where the paintbrush can be exchanged easily. The author paintbrush holders 10 are located in the operating position, where the tufts of the paintbrushes can be cleaned.

In FIG. 2, a paintbrush holder at location 11a is shown in the service position, and the second paintbrush holder at location 11b is in the operating position.

In the shown embodiment, each paintbrush holder 10 comprises at least one clamp 42 four clapming the handle of the paintbrush during the cleaning operation and thus to hold the paintbrush at a fixed location (FIG. 8).

In the embodiments shown in FIGS. 8 and 9, several clamps 42 are arranged on the gripping lever 38 at different angular positions. They are used hold paintbrushes with differing shapes, for example straight and angled paintbrushes. The user chooses, depending on the shape of the paintbrush, a suitable clamp 42 (see FIG. 9, where the holding off to different paintbrushes 1b, 1c is shown.

As also shown, each clamp advantageously has two clamping jaws 44a, 44b.

In order to be able to hold as many paintbrushes as possible with differently shaped handles, it has been found to be advantageous to design one clamping jaw (here the jaw 44a) in concave manner, for example with a U- or V-shaped recess 46, which receives the handle of the paintbrush partially. On the other side, the second clamping jaw (here the jaw 44b) can be flat or convex.

A “convex” or “concave” shape of a jaw is to be understood such that, in a sectional view perpendicular to the intended paintbrush handle axis, it is convex or concave, respectively. In a sectional view parallel along the intended paintbrush handle axis, it is advantageously flat (cf. clamping jaw 44a) of concave (cf. clamping jaw 44b).

The two clamping chores 44a, 40 4B can, for example, be pushed against each other by means of a spring.

In the shown embodiment, one of the clamping jaws 44a, 44b, preferably clamping jaw 44b, is pivotal about clamping axis 47 and can be separated from the other clamping jaw against the force of said spring.

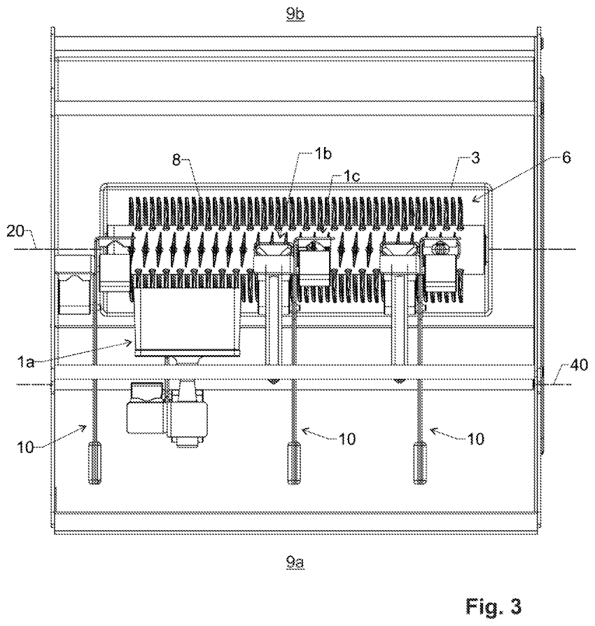

In order to receive differently broad paintbrushes, the paintbrush holders 10 are preferably displaceable along the rotational axis 20. As, for example, shown in. FIG. 3, in this way possible it is to make room for a particularly broad paintbrush 1a.

The cleaning apparatus should be dimensioned such that it is made sure, for the used paintbrush types, that the tuft can be crossed by the nozzles 8.

For painter's paintbrushes this can, for example, be achieved if the minimum distance of the clamps 42 from the nozzles 8 (i.e. the distance between the clamps 42 and the nozzles 8 in their topmost position, i.e. the position where the nozzles 8 are in a position closest to the clamps) is in the range of 1 to 12 cm.

As can be seen from FIG. 2, the clamp 42 of a paintbrush holder 10 in the service position 11b is closer to the user side 9a of the apparatus than in the operating position 11a. This simplifies the mounting and dismounting of the paintbrush. On the other side, the clamp 42 is located, in its operating position, vertically above or within the cleaning tub 3.

As further can be seen from FIG. 2, the paintbrush, in its operating position 11a, is pushed from above onto the nozzles 8, for example by gravity, such that a good contact between the nozzles 8 and the tuft 14 is guaranteed.

Cleaning Procedure:

The cleaning procedure can be adapted to the respective requirements and may, for example, depend on the type of the paintbrushes as well as on their contamination. In many cases, a process according to the following steps is advantageous:
Pre-cleaning: In the pre-cleaning phase, the paintbrush is treated in the cleaning tub 3 with water while the nozzles 8 are led through the tuft 14. In this way, the worst contaminations are removed.
Water change: The water in the cleaning tub 3 is exchanged.
Main cleaning: In the main cleaning, a cleaning agent is added to the water, in particular surfactant, such as soft soap. Again, the paintbrush in the cleaning tub 3 is treated with the water complemented in this way while the nozzles 8 are led through the tuft 14.
Water change: The water in the cleaning tub 3 is exchanged.
Rinsing: During rinsing, the paintbrush in the cleaning tub 3 is again treated with water while the nozzles 8 are led through the tuft 14. In this phase, a paintbrush treating agent may, for example, be added to the water.

To support the cleaning process, the cleaning apparatus can comprise one or more ultrasound sources 48 (FIG. 2), by means of which the tuft 14 can be cleaned by means of ultrasound.

Advantageously, the tuft 14 of the paintbrush is inserted, at least temporarily, completely into the cleaning liquid during cleaning, i.e. the liquid level in the cleaning tub 3 is at least temporarily higher than the top edge of the tuft in order to treat, for example, the whole tuft by means of ultrasound.

On the other hand, however, it is also conceivable to keep the liquid level in the cleaning tub 3 below the tuft region 15, even below the nozzle assembly 6, in particular while the nozzles 8 are moved through the tuft and dispense cleaning liquid.

Notes:

In the shown embodiment, the nozzles 8 are driven for rotation. It is, however, conceivable to move the nozzles 8 back-and-forth, for example along a straight or arcuate path.

Alternatively, the paintbrushes may be moved in respect to the nozzles 8 in order to move the nozzles 8 through the tuft. Also, the nozzles 8 as well as the paintbrushes may be moved.

In addition to a rotational movement, the nozzles 8 can execute a relative movement in respect to the paintbrush holders 10 along the rotational axis 20 such that they are not located, at each rotation, at the same axial position. This allows to clean the tuft even better. For this purpose, for example, an axial drive 15 schematically shown in FIG. 5 can be, provided, by means of which the nozzle assembly 6 and therefore the nozzles can be moved axially (i.e. along the direction of the rotational axis 20) back-and-forth. This is a relative movement, i.e. the axial drive 50 may act on the nozzles 8 or on the paintbrush holders 10.

While, in the present application, preferred embodiments of the invention are shown, it is to be pointed out that the invention is not limited thereto and can also be carried out in different manner within the scope of the following claims.

1. A cleaning apparatus for paintbrushes comprising
at least one paintbrush holder for positioning a tuft of a paintbrush in a cleaning region,
at least one nozzle for treating the tuft of the paintbrush in the cleaning region,
a cleaning liquid feed for feeding cleaning liquid to the nozzle, and
a motion device, by which the nozzle can be moved relatively to the paintbrush through the cleaning region.

2. The cleaning apparatus of claim 1 wherein the motion drive is adapted to move the nozzle.

3. The cleaning apparatus of claim 1 wherein the motion device comprises a rotatable nozzle holder as well as a motion drive for rotating the nozzle holder around the rotational axis, wherein the at least one nozzle is arranged on the nozzle holder.

4. The cleaning apparatus of claim 3 with a jet control pipe, which is arranged in the nozzle holder and comprises at least one opening such that the nozzle communicates over part of its rotation with an interior space of the jet control pipe wherein the cleaning liquid feed is adapted for feeding cleaning liquid to the interior space of the jet control pipe.

5. The cleaning apparatus of claim 3 with an axial drive for relatively moving the nozzle in respect to the paintbrush holder along a direction of the rotational axis.

6. The cleaning apparatus of claim 1 with a plurality of nozzles.

7. The cleaning device of claim 3 with a plurality of nozzles, wherein at least part of the nozzles are arranged displaced against each other along the rotational axis.

8. The cleaning apparatus of claim 3 with a plurality of nozzles, wherein at least part of the nozzles are arranged at different angular positions around the rotational axis.

9. The cleaning apparatus of claim 1, wherein the nozzles comprises, as seen in a direction of motion, an entry edge, starting from which the nozzle widens.

10. The cleaning apparatus of claim 1, wherein the paintbrush holder comprises a clamp for clamping the handle of the paintbrush.

11. The cleaning device of claim 10 wherein the paintbrush holder is movable between an operating position and a service position, wherein, in the service position, the clamp is closer to a user side of the cleaning apparatus than in the operating position.

12. The cleaning apparatus of claim 10, wherein the paintbrush holder further comprises a gripping lever pivotal about holder axis, with the clamp being arranged on the gripping lever.

13. The cleaning apparatus of claim 12, wherein the motion device comprises a rotatable nozzle holder as well as a motion drive for rotating the nozzle holder around the rotational axis, wherein the at least one nozzle is arranged on the nozzle holder,
and wherein the holder axis extends parallel to the rotational axis.

14. The cleaning apparatus of claim 1 with several paintbrush holders for several paintbrushes.

15. The cleaning apparatus of claim 10 comprising several paintbrush holders for several paintbrushes,
wherein the motion device comprises a rotatable nozzle holder as well as a motion drive for rotating the nozzle holder around the rotational axis, wherein the at least one nozzle is arranged on the nozzle holder, and
wherein the paintbrush holders are arranged along the rotational axis in spaced apart manner.

16. The cleaning device of claim 1 wherein the cleaning device comprises one or more ultrasound sources for treating the tuft with ultrasound.

17. A method for operating the cleaning apparatus of claim 1, wherein the nozzle is moved relatively to the paintbrush through the tuft.

18. The method of claim 17 wherein cleaning liquid is ejected through the nozzle while it is moved through the tuft.

19. The method of claim 17 wherein, for cleaning the paintbrush, at least the following phases are executed:
in a pre-cleaning phase, the paintbrush is treated with water in the cleaning tub while the nozzle(s) is or are moved through the tuft,
the water in the cleaning top is exchanged.
in main cleaning, a cleaning agent is added to the water, and the paintbrush is treated in the cleaning tub with the water while the nozzle(s) is or are moved through the tuft.

20. The cleaning apparatus of claim 3 further comprising a cleaning tub, wherein the nozzle holder and the nozzle(s) are arranged in the cleaning tub.

21. The cleaning apparatus of claim 10 wherein the clamp comprises a first concave and the second flat or convex clamping jaw.

22. The cleaning apparatus of claim 11 wherein the clamp is located, in the operating position, vertically above or within a cleaning tub in which the at least one nozzle is located.

23. The cleaning apparatus of claim 12 wherein several clamps are arranged under different angular positions on the gripping lever for receiving straight and angled paintbrushes.

24. The cleaning apparatus of claim 15 wherein the paintbrush holders are displaceable along the rotational axis.

25. A cleaning apparatus for paintbrushes comprising
at least one paintbrush holder,
at least one nozzle,
a cleaning liquid feed connected to the nozzle, and
a motion device, by which the nozzle can be moved relatively to the paintbrush through the cleaning region.
